(19) United States
(12) Patent Application Publication
(10) Pub. No.: US 2006/0063555 A1
(43) Pub. Date: Mar. 23, 2006

(54) Device, system and method of pre-defined power regulation scheme

(76) Inventor: Matthew Robbins, Shoam (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/947,143

(22) Filed: Sep. 23, 2004

(51) Int. Cl. H04B 7/00

(52) U.S. Cl. 455/522; 514/69

(57) ABSTRACT

Briefly, some embodiments of the invention may provide devices, systems and methods of pre-defined power-regulation scheme. For example, an apparatus in accordance with an embodiment of the invention may include a power management unit to receive a status signal corresponding to an operational status of said apparatus and, in response to said status signal, to control one or more operational parameters of one or more components of said apparatus based on a pre-defined scheme.

### BACKGROUND OF THE INVENTION

A wireless communication device may include, for example, a Power Management Integrated Circuit (PMIC) to control the power provided to a processor and to other components of the wireless communication device. To activate, de-activate or change an operational parameter of these components, the processor transfers to the PMIC a plurality of power regulation instructions, which are then executed by the PMIC. Therefore, a significant software overhead or processor overhead may be required, for example, for activating or de-activating a plurality of components of the wireless communication device.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system including one or more wireless communication devices utilizing a pre-defined power regulation scheme in accordance with exemplary embodiments of the invention;

FIG. 2 is a schematic block diagram illustration of a wireless communication device utilizing a pre-defined power regulation scheme in accordance with exemplary embodiments of the invention; and

FIG. 3 is a schematic flow-chart of a method of power regulation using a pre-defined scheme in accordance with exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a transmitter, a receiver, a transceiver, a wireless communication station, a wireless communication device, a wireless Access Point (AP), a processor, a controller, a power management unit, a Power Management Integrated Circuit (PMIC), a power management controller or processor, a modem, a wireless modem, a personal computer, a desktop computer, a mobile computer, a laptop computer, a notebook computer, a Personal Digital Assistant (PDA) device, a tablet computer, a server computer, a cellular telephone, a wireless telephone, a Personal Communication Systems (PCS) device, a PDA device which incorporates a wireless communication device, or the like. Although part of the discussion herein may relate to a wireless communication device and to components of a wireless communication device, embodiments of the invention are not limited in this regard, and may be used in various other apparatuses, devices, stations, computing platforms, systems and/or networks.

The term “operational status” as used herein may refer, for example, to whether a device, an apparatus or a component is in an active mode, in a non-active mode, or in another mode of operation. Such modes may include, for example, an idle mode, a standby mode, a power conservation mode, an efficiency mode, a reduced power mode, a semi-active mode, a “sleep” mode, a “drowsy” mode, a fully operational mode, a partially operational mode, or other suitable modes of operation or activation in which a component or a device may be.

The term “connector” as used herein may include, for example, a wire, a cable, a hardware link, a pin, a hardware pin, a port, a bus, or other suitable connection unit or connection mechanism.

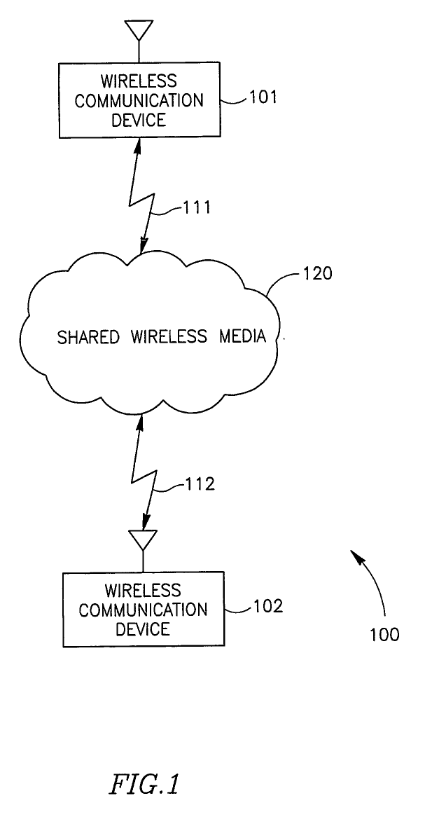

FIG. 1 schematically illustrates a block diagram of a wireless communication system 100 including one or more wireless communication devices utilizing a pre-defined power regulation scheme in accordance with exemplary embodiments of the invention. System 100 may include one or more wireless communication devices, for example, devices 101 and 102.

Device 101 and device 102 may communicate between themselves over a shared wireless media 120, which may include, for example, wireless communication links 111 and 112. For example, device 101 may communicate with one or more other devices of system 100 through link 111, and device 102 may communicate with one or more other devices of system 100 through link 112.

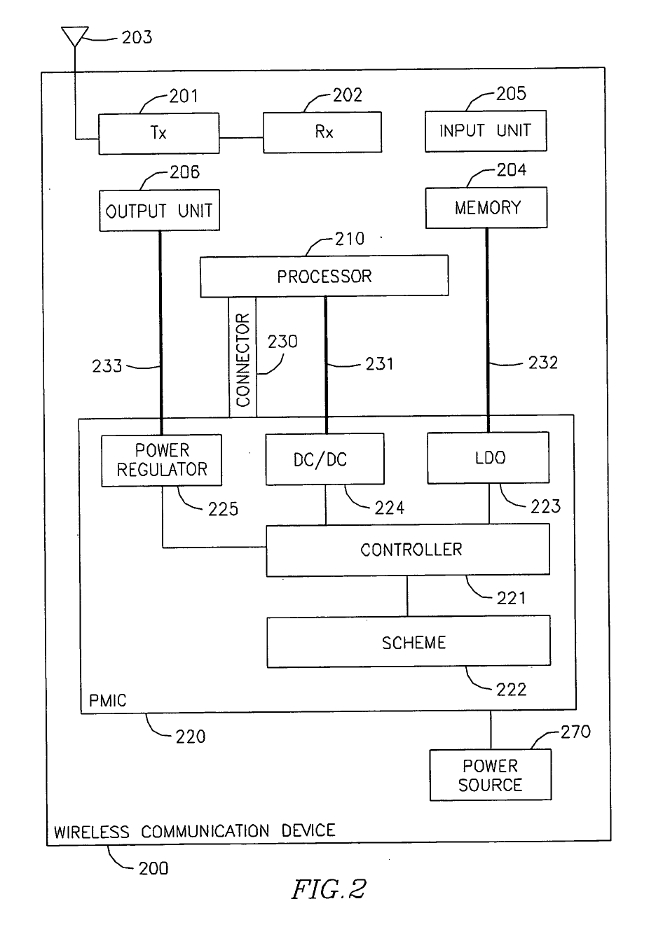

FIG. 2 schematically illustrates a block diagram of a wireless communication device 200 utilizing a pre-defined power regulation scheme in accordance with exemplary embodiments of the invention. Device 200 may be an example of device 101 and/or device 102. Device 200 may include a processor 210 connected through a connector 230 to a power management controller or a power management unit, for example, a PMIC 220. Additionally, device 200 may include, for example, a transmitter 201, a receiver 202, an antenna 203, a memory unit 204, an input unit 205, an output unit 206, a power source 270, and/or any other suitable hardware components and/or software components as are known in the art and/or as described herein.

Transmitter 201 may include, for example, a Radio Frequency (RF) transmitter able to generate and send wireless communication signals. Receiver 202 may include, for example, a RF receiver able to receive wireless communication signals. In some embodiments, transmitter 201 and receiver 202 may be implemented in the form of a transceiver, a transmitter-receiver, or one or more units able to perform separate or integrated functions of generating, sending and/or receiving wireless communication signals, blocks, frames, packets, messages and/or data.

Antenna 203 may include an internal and/or external RF antenna. In some embodiments, for example, antenna 203 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, packets, messages and/or data.

Memory unit 204 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. In some embodiments, for example, memory unit 204 may store data transmitted or received by device 200.

Input unit 205 may include, for example, a keypad, a keyboard, one or more keys, a touchpad, a joystick, a mouse, a pointing device, a user interface, one or more buttons, one or more switches, one or more sliders, an on/off button or switch, or other suitable input components. In some embodiments, input unit 205 may input a suitable audio input component, e.g., an internal or external microphone, and/or a suitable video input component, e.g., an internal or external photo camera or a video camera.

Output unit 206 may include, for example, a screen or monitor. In some embodiments, output unit 206 may include a suitable audio output component, e.g., one or more speakers, earphones or headphones. Output unit 206 may optionally include other types of indicators, for example, a vibrator able to vibrate, or a Light Emitting Diode (LED) able to illuminate.

Power source 270 may include one or more batteries or power cells, which may be external and/or internal, rechargeable or non rechargeable. Power source 270 may provide power to be used by one or more components of device 200, for example, PMIC 220 as described below.

Processor 210 may include, for example, a Central Processing Unit (CPU), a Digital Signal Processor (DSP), a baseband processor, an application-side processor, a processor core, a microprocessor, a controller, a chip, a microchip, or any other suitable multi-purpose or specific processor or controller. In some embodiments, for example, processor 210 may perform calculation operations or processing operations, which may be used in producing signals transmitted by device 200 or in processing signals received by device 200.

PMIC 220 may include, for example, a power management unit, controller, circuit, or integrated circuit. PMIC 220 may receive power from power source 270, and may provide power to one or more components of device 200, e.g., to transmitter 201, to receiver 202, to memory unit 204, to input unit 205, to output unit 206, to processor 210, or to other power-consuming components of device 200.

PMIC 220 may include, for example, one or more Direct Current to Direct Current (DC/DC) converters 224, one or more Low DropOut regulators (LDOs) 223, or one or more other power regulators 225.

DC/DC converter 224 may, for example, receive an input voltage from power source 270, and increase or decrease the input voltage to produce an output voltage which may be provided to a component of device 200. DC/DC converter 224 may, for example, provide power through a connector 231 to processor 210, or to a component of device 200 which may require a relatively high current.

LDO 223 may, for example, receive an input voltage from power source 270, and decrease the input voltage to produce an output voltage which may be provided to a component of device 200. LDO 223 may, for example, provide power through a connector 232 to memory unit 204, or to a component of device 200 which may require a relatively low current.

Power regulator 225 may include other suitable units, e.g., a charge-pump, able to receive power from power source 270, to increase, decrease and/or stabilize the received power, and to provide the increased, decreased or stabilized power, respectively, to a power-consuming component of device 200, e.g., to output unit 206 through a connector 233.

In some embodiments, the operation of DC/DC converters 224, LDOs 223 and power regulators 225 may be controlled by PMIC 220, e.g., using a control unit or controller 221 which may be integrated or embedded within PMIC 220.

Connector 230 may connect processor 210 to PMIC 220, and may include, for example, a cable, a wire, a hardware pin, a pin, an electrical connection, a port, a bus, or other suitable wired or wireless link or connection. Optionally, in one embodiment, PMIC 220 may include an input connector or an input socket or pin, processor 210 may include an output connector or an output socket or pin, and connector 230 may include or may connect such input/output parts of PMIC 220 and/or processor 210.

In accordance with some embodiments of the invention, an operational status of device 200 or processor 210 may be set or switched. In one embodiment, for example, a user may turn on or turn off device 200, e.g., using input unit 205, and as a result, the operational status of processor 210 may be set, e.g., from an active mode to a non-active or semi-active mode. In an alternate embodiment, for example, device 200 and/or processor 210 may automatically switch into a non-active mode or a semi-active mode, for example, if device 200 is idle for a pre-defined period of time. In yet another embodiment, device 200 and/or processor 210 may switch into an active mode when a pre-defined condition is met, e.g., when a signal is received by receiver 202 indicating an incoming communication, or when a user operates the input unit 205.

In some embodiments, when the operational status of device 200 and/or processor 210 is switched or set to a new status, processor 210 may send a signal or an indication to PMIC 220 through connector 230, e.g., a signal representing or corresponding to the operational status. In one embodiment, for example, the signal may include a one-bit data item, e.g., wherein a content of “1” indicates that processor 210 is in active mode and a content of “0” indicates that processor 210 is in non-active mode, or vice versa. In an alternate embodiment, for example, the signal may include a command, an instruction, an operational status indicator, a message, or another data item indicating an operational status of processor 210 and/or device 200, or indicating a change in the operational status of processor 210 and/or device 200.

In some embodiments, the signal may be received by PMIC 220, for example, by controller 221 of PMIC 220. Upon receiving the signal, controller 221 may control, set or modify an operational parameter or an operational property of one or more components of PMIC 220 in accordance with a pre-defined power regulation scheme, and, thus, may modify the operation of one or more components of device 200 in accordance with a pre-defined scheme. In some embodiments, the received signal may be, or may include, a scheme-triggering signal or a signal triggering the execution of a power regulation scheme. For example, the scheme-triggering signal may be received by PMIC 220 and may trigger the execution of a pre-defined power regulation scheme, e.g., one or more operations or a sequence of operations controlling, modifying, setting or regulating power provided to components of device 200, or controlling, modifying or setting an operational parameter of one or more components of device 200. In one embodiment, for example, the scheme-triggering signal may include a bit, a byte, an instruction, a status signal, a message or a data item, triggering an execution of a plurality of power regulating operations and/or triggering a modification or a setting or one or more operational parameters of various components of device 200.

In one embodiment, for example, PMIC 220 may receive from processor 210 a signal representing that processor 210 is in non-active mode, or that device 200 is in non-active mode. In response to the received signal, controller 221 may turn-off or de-activate one or more components of PMIC 220, for example, LDO 223, DC/DC converter 224, and/or power regulator 225. This may result in, for example, turning off or de-activating one or more components of device 200, or otherwise controlling, setting or modifying an operational parameter of a component of device 200.

In one embodiment, for example, PMIC 220 may receive from processor 210 a signal representing that that processor 210 is in active mode, or that device 200 is in active mode. In response to the received signal, controler 221 may turn-on or activate one or more components of PMIC 220, for example, LDO 223, DC/DC converter 224, and/or power regulator 225. This may result in, for example, turning on or activating one or more components of device 200, or otherwise controlling, setting or modifying an operational parameter of a component of device 200.

In some embodiments, in response to the received signal, status signal, or scheme-triggering signal, controller 221 may control or regulate power in accordance with a pre-defined power regulation scheme, which may be pre-stored or pre-programmed in device 200. In one embodiment, for example, PMIC 220 may include a scheme storage unit 222, which may include a memory unit or a storage unit able to store a pre-defined power regulation scheme. Scheme storage unit 222 may include one or more data items indicating an operation or a set of operations which PMIC 220 or controller 221 may execute upon receiving a certain signal, indication, or type of indication from processor 210.

For example, in one embodiment, scheme storage unit 222 may include a data item indicating that in response to an indication that device 200 or processor 210 is in non-active mode, controller 221 may instruct DC/DC converter 223 to decrease the voltage provided to processor 210. In another embodiment, for example, scheme storage unit 222 may include a data item indicating that in response to an indication that device 200 or processor 210 is in active mode, controller 221 may instruct LDO 224 increase the voltage provided to memory unit 204.

In some embodiments, scheme storage unit 222 may include data items indicating a plurality of operations that may be executed upon receiving the signal or indication from processor 210. In one embodiment, scheme storage unit 222 may store data indicating a sequence in which power regulating operations may be performed, or an order in which power regulating instructions may be executed. In one embodiment, for example, scheme storage unit 222 may include data indicating that an operational parameter of a first component may be controlled, set or modified before, or only after, an operational parameter of a second component is controlled, set or modified. In another embodiment, for example, scheme storage unit 222 may include data indicating that LDO 223 may be de-activated only after DC/DC converter 224 is de-activated, or that the power provided by power regulator 225 may be increased before the power provided by LDO 223 is modified.

In some embodiments, scheme storage unit 222 may include data items indicating a property of a change in power regulation, for example, a data item indicating a need or a command to perform a gradual increase or gradual decrease of voltage or current, a data item indicating a need or a command to perform a delayed or deferred activation or de-activation of a power regulating component, or the like. In some embodiments, scheme storage unit 222 may include data items indicating various other schemes, instructions, operations, or sequence of operations.

In some embodiments, scheme storage unit 222 may store data in accordance with a pre-defined format or pattern to indicate a certain power regulation scheme. For example, scheme storage unit 222 may include one or more tables, lookup tables, maps, registers, map registers, databases, RAM tables, ROM tables, or other suitable data formats.

In one embodiment, for example, data describing the power regulation scheme stored in scheme storage unit 222 may be programmable or modifiable, e.g., the data may be stored using a lookup table or a map register which may be dynamically re-programmed during the operation of device 200, e.g., substantially in real-time. In an alternate embodiment, for example, data describing the power regulation scheme stored in scheme storage unit 222 may be non-programmable or non-modifiable, e.g., using a lookup table, a ROM unit or a map register which may not be re-programmed or modified during the operation of device 200.

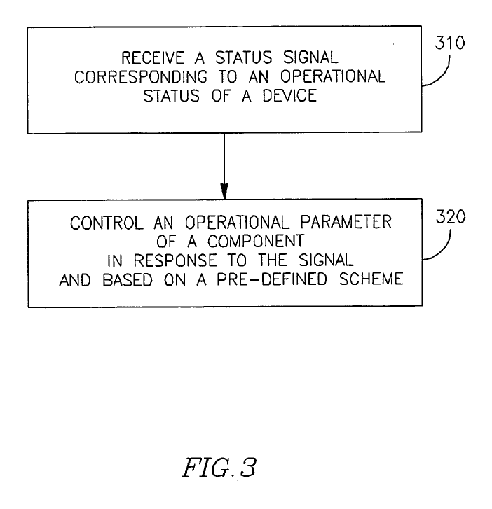

FIG. 3 is a schematic flow-chart of a method of power regulation using a pre-defined scheme in accordance with exemplary embodiments of the invention. The method may be used, for example, by system 100 of FIG. 1, by one or more of devices 101 and 102 of FIG. 1, by device 200 of FIG. 2, by processor 210 and/or PMIC 220 and/or control unit 221 of FIG. 2, or by other suitable processors, controllers, power management units, power regulators, PMIC units, wireless communication devices, stations, systems and/or networks.

As indicated at box 310, the method may begin, for example, by receiving a signal corresponding to an operational status of a wireless communication device or of a component of a wireless communication device, e.g., of processor 210 or device 200. The signal may be received, for example, by PMIC 220 or control unit 221.

As indicated at box 320, the method may include, for example, setting, controlling or modifying an operational parameter or an operational property of a component of the wireless communication device, e.g., of device 200, in response to the received signal and based on a pre-defined scheme. This may include, for example, increasing or decreasing voltage or current provided to a component of device 200, e.g., by PMIC 220, by LDO 223, by DC/DC converter 224, or by power regulator 225.

In some embodiments, the operations of box 320 may optionally include, for example, accessing a scheme storage unit, e.g., scheme storage unit 222, to read a data item indicating one or more power regulating operations which may be performed in response to the received signal.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by device 101, by device 102, by device 200, by processor 210, by PMIC 220, by controller 221, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 204), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a power management unit to receive a status signal corresponding to an operational status of said apparatus and, in response to said status signal, to control one or more operational parameters of one or more components of said apparatus based on a pre-defined scheme.

2. The apparatus of claim 1, comprising a processor to provide said status signal to said power management unit.

3. The apparatus of claim 2, wherein said status signal corresponds to an operational status selected from a group consisting of a non-active mode of said processor, an active mode of said processor, a semi-active mode of said processor, a non-active mode of said apparatus, a semi-active mode of said apparatus, and an active mode of said apparatus.

4. The apparatus of claim 2, wherein said power management unit comprises an input connector to receive said status signal from said processor.

5. The apparatus of claim 4, wherein said input connector comprises a hardware pin.

6. The apparatus of claim 2, comprising a memory to store said pre-defined scheme.

7. The apparatus of claim 3, wherein said memory comprises a lookup table.

8. The apparatus of claim 3, wherein said memory comprises a register.

9. The apparatus of claim 3, wherein said memory comprises a Read Only Memory.

10. The apparatus of claim 1, wherein said pre-defined scheme is programmable.

11. The apparatus of claim 1, wherein said one or more components comprises one or more components selected from a group consisting of an input unit, an output unit, a processor, a memory unit, a transmitter, and a receiver.

12. The apparatus of claim 1, wherein said power management unit comprises a power regulator to regulate a power supply to said one or more components.

13. The apparatus of claim 1, wherein said power management unit comprises a Direct Current to Direct Current converter to convert a voltage supply to said one or more components.

14. The apparatus of claim 1, wherein said power management unit comprises a Low DropOut regulator to decrease a power supply to said one or more components.

15. An apparatus comprising:
a processor operatively connected to a power management unit and able to provide to said power management unit a scheme-triggering signal corresponding to an operational status of a said processor,
wherein said power management unit is able, in response to said scheme-triggering signal, to control an operational parameter of one or more components of said apparatus based on a pre-defined scheme.

16. The apparatus of claim 14, wherein said scheme-triggering signal corresponds to an operational status selected from a group consisting of a non-active mode of said processor, an active mode of said processor, a semi-active mode of said processor, a non-active mode of said apparatus, a semi-active mode of said apparatus, and an active mode of said apparatus.

17. The apparatus of claim 14, wherein said power management unit comprises an input connector to receive said scheme-triggering signal from said processor.

18. A wireless communication device comprising:
a dipole antenna to send and receive wireless communication transmissions; and
a power management unit to receive a status signal corresponding to an operational status of said apparatus and, in response to said status signal, to control one or more operational parameters of one or more components of said apparatus based on a pre-defined scheme.

19. The wireless communication device of claim 18, comprising a processor to provide said status signal to said power management unit.

20. The wireless communication device of claim 19, wherein said status signal corresponds to an operational status selected from a group including a non-active mode of said processor, an active mode of said processor, a semi-active mode of said processor, a non-active mode of said wireless communication device, a semi-active mode of said wireless communication device, and an active mode of said wireless communication device.

21. A wireless communication system comprising:
a wireless communication device comprising:
a power management unit to receive a status signal corresponding to an operational status of said wireless communication device and, in response to said status signal, to control one or more operational parameters of one or more components of said wireless communication device based on a pre-defined scheme.

22. The wireless communication system of claim 21, wherein said wireless communication device comprises a processor to provide said status signal to said power management unit.

23. The wireless communication system of claim 22, wherein said status signal corresponds to an operational status selected from a group including a non-active mode of said processor, an active mode of said processor, a semi-active mode of said processor, a non-active mode of said first wireless communication device, a semi-active mode of said first wireless communication device, and an active mode of said first wireless communication device.

24. The wireless communication system of claim 21, wherein said wireless communication device is able to communicate with another wireless communication device.

25. A method comprising:
receiving a status signal corresponding to an operational status of a component of a device; and
in response to said status signal, controlling an operational parameter of one or more components of said device based on a pre-defined scheme.

26. The method of claim 25, wherein said controlling comprises controlling a voltage provided to said one or more components.

27. The method of claim 25, wherein said controlling comprises controlling a current provided to said one or more components.

28. The method of claim 25, wherein said controlling comprises controlling in accordance with a pre-defined sequence of operations indicated by said pre-defined scheme.

29. The method of claim 25, wherein said controlling comprises activating said one or more components.

30. The method of claim 25, wherein said controlling comprises de-activating said one or more components.
